(19) United States
(12) Patent Application Publication
(10) Pub. No.: US 2012/0017249 A1
(43) Pub. Date: Jan. 19, 2012

(54) DELIVERY SYSTEM, DELIVERY METHOD, CONVERSION APPARATUS, AND PROGRAM

(76) Inventor: Kazunori Ozawa, Tokyo (JP)

(21) Appl. No.: 13/258,908

(22) PCT Filed: Apr. 1, 2010
(86) PCT No.: PCT/JP2010/056013

§ 371 Date: Sep. 22, 2011

(30) Foreign Application Priority Data
Apr. 3, 2009 (JP) 2009-091326

(51) Int. Cl. H04N 7/18; H04N 7/173

(52) U.S. Cl. 725/81; 725/110; 725/78

(57) ABSTRACT

A conversion apparatus is provided for a system that delivers content to a first terminal comprising a set top box in home or the like from a delivery server apparatus over a first network. When a request for content is made from a second terminal over a second network, the conversion apparatus sends a request to the delivery server apparatus. The conversion apparatus performs conversion of the content sent from the delivery server apparatus with regard to at least one of the second terminal, the second network, and the first network. Then, the conversion apparatus sends converted content to the second terminal over the second network.

### TECHNICAL FIELD

### DESCRIPTION OF RELATED APPLICATION

The present invention is based upon and claims the benefit of the priority of Japanese Patent Application No. 2009-091326 (filed on Apr. 3, 2009), the disclosure of which is incorporated herein in its entirety by reference.

The present invention relates to an information delivery technology. More specifically, the invention relates to a delivery system, a delivery method, a conversion apparatus, and a program for delivering content including at least one of a moving image, a still image, and audio to a terminal over a network.

### BACKGROUND

Accompanied with the advance in broadband implementation of fixed network, implementation of NGN (Next Generation Network), and increase in speed and capacity of mobile network, content delivery for delivering content including video (still image, moving image, or the like) and/or audio to a set top box or a television (TV) in home over one of the networks is becoming widespread. Further, a service provided by IPTV technology or the like that utilizes an advantage of the NGN network will be started in the future.

The speed and capacity of the mobile network are also scheduled to be increased in the future according to LTE (Long Term Evolution) technology, EPC (Evolved Packet Core) technology, or the like.

Patent Document 1 discloses an information delivery system including an information delivery server (Web server), an information terminal (user PC), and an information delivery portal server, all of which are connected to a network (Internet, or network other than the Internet in which a cellular phone network, a public phone network, a LAN, and various networks are combined). In this system, resource information in the information terminal (user PC) is investigated. Information in the Web server is processed, based on processing rule information that defines processing content of the information obtained from the information delivery server (Web server) over the network. Specifications of the information terminal possessed by a user are recognized in detail. Then, information is delivered in the form of content data optimal for the information terminal (user PC).

Patent Document 2 discloses a configuration in which an agent for converting content data transmitted to a user terminal from a content server is provided for a router. When a request for content is made from each of user terminals respectively connected to a communication network (1a: Internet, fixed telephone communication network, wireless LAN, or the like) and a communication network (1b: mobile communication network), content data associated with the request is fetched from the content server. Format conversion of the content data is performed so that the content data is adapted to each of the user terminals, and the format-converted content data is transmitted to each of the user terminals. Conversion of the content is thereby enabled by a user of the content.

### Patent Document 1:

JP Patent Kokai Publication No. JP-P-2005-327150A

### Patent Document 2:

JP Patent Kokai Publication No. JP-P-2005-339149A

### SUMMARY

The following analyses are given by the present invention.

In services provided so far, apparatuses that can receive content delivery are limited to a set top box installed in home and a TV or a DVD (Digital Versatile Disk) recorder, or the like, connected to the set top box. Accordingly, various terminals (such as game apparatus, digital photo frame and the like) that are not connected to the set top box cannot receive the delivery. Still less, a portable terminal for a cellular phone connected to the outside of home cannot receive the delivery.

Assume that video and/or audio content is received by various terminals (such as game apparatus, digital photo frame, and the like) or a portable terminal and the video and/or audio content is decoded for display. Then, when the content is encoded and encoded information does not conform to capability information relating to the terminal, it becomes difficult for the terminal to decode a moving image stream. Then, a problem arises that the moving image cannot be displayed or the image is distorted.

Further, when bit rate, resolution, codec, file format, protocol, or the like does not conform to that of the terminal, there is a problem that the terminal cannot even decode the moving image stream.

Patent Document 1 described above discloses the configuration in which the information delivery portal server delivers Web information (on an address and a font) and information on a home page or the like to the information terminal (user PC). Patent Document 1 described above discloses no configuration in which content including video and/or audio are processed. Further, in Patent Document 2 described above, the agent on the router prepared for by a user himself performs format conversion of content to be transmitted to the user terminal connected to a router so that the content is adapted to the user terminal. That is, Patent Documents 1 and 2 described above do not disclose a configuration for delivering content including video and/or audio from a delivery server to a first terminal comprising a set top box in home over a first network and allowing delivery of the same content to a portable terminal over a second network.

An object of the present invention is to provide a delivery system, a delivery method, and an apparatus, and a program in which, in the system including a delivery server of delivering content to a first terminal over a first network, a service of delivering the same content to a second terminal in a second network can be implemented, without preparing content for each terminal in advance.

According to the present invention, there is provided a delivery system that delivers content from a delivery server to a first terminal over a first network, wherein the delivery system comprises

a conversion apparatus connected to the first network and a second network, wherein the conversion apparatus, on receipt of a request from a second terminal over the second network, sends a request to the delivery server, and

when conversion of content sent from the delivery server that receives a request is necessary with regard to at least one of

the second terminal,

the second network, and

the first network,

the conversion apparatus performs the conversion, and sends the converted content to the second terminal over the second network.

According to the present invention, there is provided a delivery method, comprising:

delivering content from a delivery server to a first terminal over a first network;

sending a request to the delivery server, when the request is made from a second terminal over a second network; and

performing conversion of the content sent from the delivery server that receives the request, when the conversion of the content is necessary with regard to at least one of

the second terminal,

the second network, and

the first network, and sending the converted content to the second terminal over the second network.

According to the present invention, there is provided a conversion apparatus connected to a delivery server over a first network and connected to a second terminal over a second network, the delivery server delivering content to a first terminal over the first network, the conversion apparatus comprising:

a conversion unit that sends a request to the delivery server, on receipt of a request from the second terminal over the second network; and that when the conversion of the content is necessary with regard to at least one of the second terminal, the second network, and the first network, performs conversion of content sent over the first network from the delivery server that receives the request and sends the converted content to the second terminal over the second network.

According to the present invention, there is provided a program for a computer constituting a conversion apparatus connected to a delivery server over a first network and connected to a second terminal over a second network, the delivery server delivering content to a first terminal over the first network, the program causing the computer to perform processing including:

sending a request to the delivery server, on receipt of a request from the second terminal over the second network; and

performing, when conversion of the content is necessary with regard to at least one of

the second terminal,

the second network, and

the first network, conversion of content sent over the first network from the delivery server and sending converted content to the second terminal over the second network.

According to the present invention, in a system including a delivery server of delivering content to a first terminal over a first network, a service of delivering the same content to a second terminal in a second network can be implemented, without preparing content for each terminal in advance.

Still other features and advantages of the present invention will become readily apparent to those skilled in this art from the following detailed description in conjunction with the accompanying drawings wherein only exemplary embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a diagram showing a connection configuration in a first exemplary embodiment of the present invention;

FIG. 2 is a diagram showing a configuration of a conversion apparatus 110 in FIG. 1; and

FIG. 3 is a diagram showing a connection configuration in a second exemplary embodiment of the present invention.

### PREFERRED MODES

The following describes exemplary embodiments of the present invention. In each of the following exemplary embodiments, there is shown a configuration example when a moving image is used as an example of content. In the case of a still image, audio, or a voice as well, a configuration similar to the above-mentioned configuration can be used.

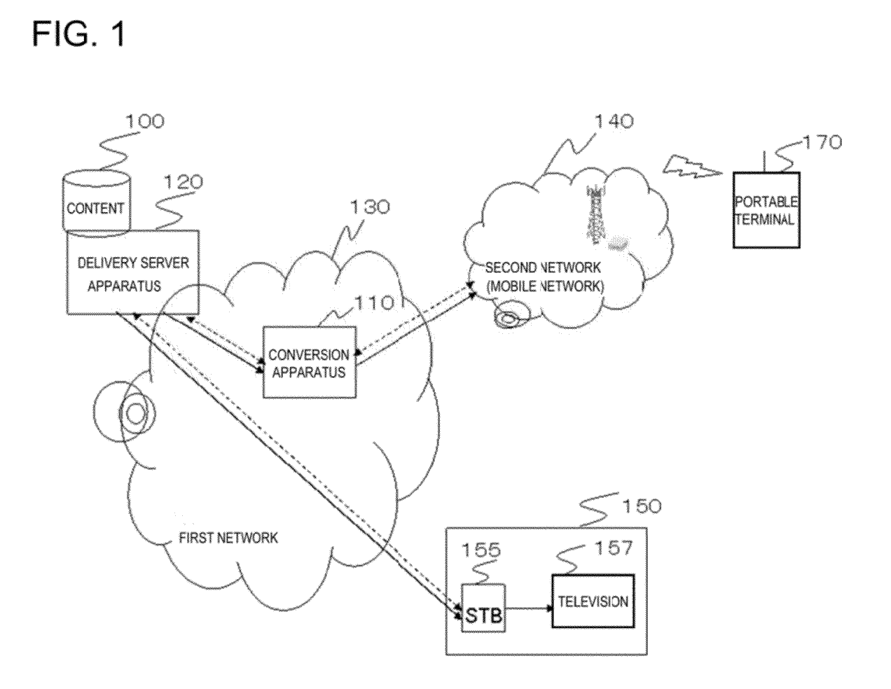

FIG. 1 is a diagram showing a system configuration in a first exemplary embodiment of the present invention. Referring to FIG. 1, a delivery server apparatus 120 accumulates compression encoded bit streams or files of content, each including at least one of a moving image, a still image, audio, and a voice in content 100 in advance.

A TV 157 makes a request for connecting to content to be viewed and/or listened to the delivery server apparatus 120 over a first network 130 through an STB (set top box) 155.

The first network 130 may be one of the following networks:

IP (Internet Protocol) network;

Broadband network;

NGN (Next Generation Network); and

Internet network mutually connected by a TCP/IP protocol.

When the delivery server apparatus 120 receives a request for connecting to content to be viewed and/or listened to from the TV 157 over the first network 130 through the STB 155, the delivery server apparatus 120 encrypts a compression encoded stream related to the requested moving image content for copy right protection, and delivers the compression encoded stream to the STB 155 over the first network 130.

As the compression encoded stream of the moving image content, a stream that has been compression encoded by MPEG-2 (Moving Picture Expert Group Phase 2) in advance, for example, can be employed.

The STB 155 receives the encrypted compression encoded stream, deciphers the encryption, and decodes the deciphered compression encoded stream using an MPEG-2 decoder, and outputs the decoded stream to the TV 157.

The TV 157 receives the decoded stream and displays the decoded stream on a display unit. The MPEG-2 decoding process may also be performed by the TV 157 rather than the STB 155.

Next, when a portable terminal 170 makes a connection request to a conversion apparatus 110 from the outside of home (outdoors) or the like over a second network (such as a mobile network) 140, using a specific protocol, for example, the conversion apparatus 110 disposed on the first network 130 receives a connection request signal. As the specific protocol from the portable terminal 170, an HTTP (Hyper Text Transport Protocol) or the like, for example, can be employed.

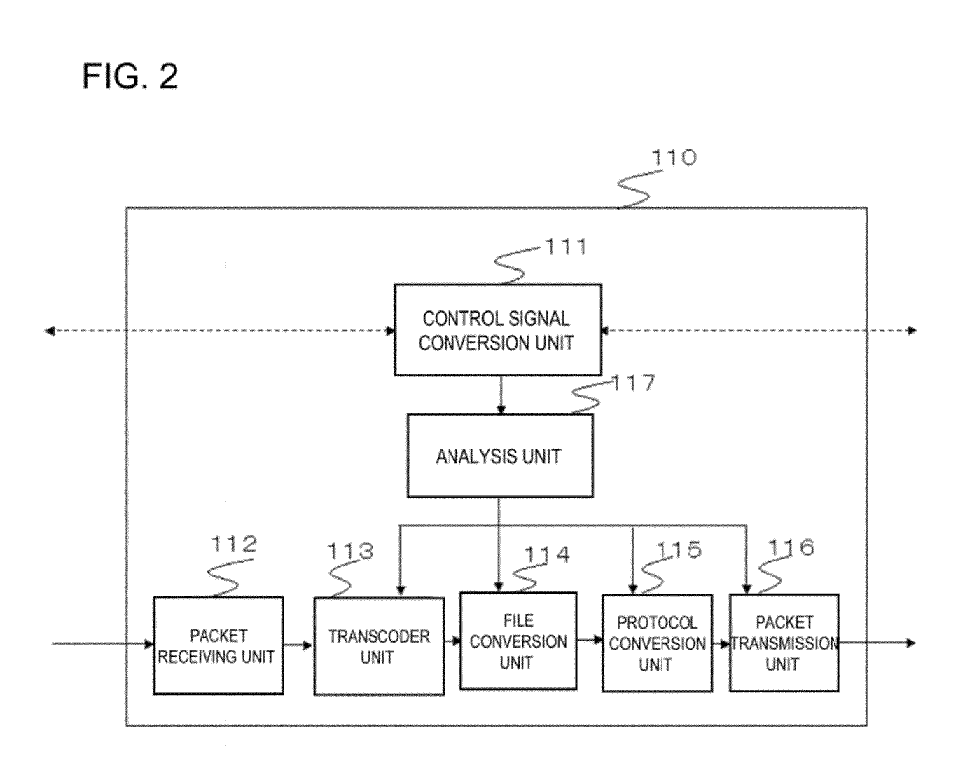

FIG. 2 is a diagram showing a configuration of the conversion apparatus 110. Referring to FIG. 2, the conversion apparatus 110 includes a control signal conversion unit 111, a packet receiving unit 112, a transcoder unit 113, a file conversion unit 114, a protocol conversion unit 115, and a packet transmission unit 116.

The control signal conversion unit 111 converts a specific protocol received from the portable terminal 170 to a protocol that can be accepted by the delivery server apparatus 120, and then serves like a proxy to send out a connection request to the delivery server apparatus 120.

The protocol obtained by the conversion depends on a function of the delivery server apparatus 120. RTSP (Real Time Streaming Protocol) or SIP (Session Initiation Protocol) or the like, for example, can be employed as the protocol obtained by the conversion. Besides the connection request, the conversion apparatus 110 notifies a receiving IP address, a receiving port number, codec capability information of the conversion apparatus 110, and the like to the delivery server apparatus 120, using SDP (Session Description Protocol) protocol or the like, for example. Regarding SIP and SDP, IETF (the Internet Engineering Task Force) RFC 3261 and RFC 2327 can be respectively referred to, for example. Regarding RTSP, RFC 2326 can be referred to.

In the specific protocol from the portable terminal 170, such as HTTP, for example, SDP or the like cannot be used. Thus, terminal type information is described in the HTTP.

The control signal conversion unit 111 receives at least one of terminal type information, information on the network to be used for connection (characteristic information such as type and bandwidth of the network), and the like, and outputs the received information to the analysis unit 117 as capability information.

Next, when a connection request from the portable terminal 170 is accepted in the delivery server apparatus 120, the portable terminal 170 selects video content desired to be viewed. A content selection signal is transferred to the conversion apparatus 110 using the specific protocol.

The conversion apparatus 110 converts the specific protocol to RTS, SIP, or the like, and sends the content selection signal to the delivery server apparatus 120.

The delivery server apparatus 120 reads a compression encoded stream corresponding to the selected content from the content 100, and stores the compression encoded stream in an RTP (Real-time Transport Protocol) packet defined in IETF RFC 3267, for example, and sends the RTP packet to the conversion apparatus 110.

The delivery server apparatus 120 sends capability information on the selected content to the conversion apparatus 110 using a protocol such as SDP.

Referring back to FIG. 2, the control signal conversion unit 111 of the conversion apparatus 110 receives SDP or the like from the delivery server apparatus 120, and extracts capability information on the selected content (information on codec by which the content have been compression encoded, screen resolution of a video, bit rate, frame rate, whether the content is in the form of a stream or a file, and the like), and outputs the capability information on the selected content to the analysis unit 117.

The analysis unit 117 receives from the control signal conversion unit 111 the capability information from the terminal and the capability information on the content from the delivery server apparatus 120, and determines whether or not conversion is necessary for the video content sent from the delivery server apparatus 120.

The analysis unit 117 determines required conversion content when the conversion is necessary. The analysis unit outputs an instruction to at least one of the transcoder unit 113, the file conversion unit 114, and the protocol conversion unit 115.

Content of the instruction for conversion from the analysis unit 117 to the transcoder unit 113 includes at least one of the following conversions:

codec conversion;

screen resolution conversion;

frame rate conversion; and

bit rate conversion.

The instruction to the file conversion unit 114 includes at least one of the following:

generation of file format (such as 3GP file format, MP4 file format, or the like); and

generation of Flash (Flash) file.

The instruction to the protocol conversion unit 115 from the analysis unit 117 includes conversion from RTP/UDP (User Datagram Protocol) to HTTP/TCP (Transmission Control Protocol).

When the conversion is unnecessary, the analysis unit 117 outputs an instruction indicating that the conversion is unnecessary to at least one of the transcoder unit 113, the file conversion unit 114, and the protocol conversion unit 115.

The packet receiving unit 112 receives the stream from the delivery server apparatus 120, extracts an MPEG-2 compression encoded stream, and then outputs the extracted MPEG-2 compression encoded stream to the transcoder unit 113.

In case the transcoder unit 113 receives from the analysis unit 117 an instruction for conversion of at least one of the following conversions:

codec conversion;

screen resolution conversion;

frame rate conversion; and

bit rate conversion, the transcoder unit 113 performs a corresponding conversion.

As one example, in case the transcoder 113 receives the following instructions:

codec conversion (MPEG 2 to MPEG-4 conversion, for example);

screen size conversion (from D1 resolution to resolution of QVGA (Quarter VGA (Video Graphic Array): 320×240 pixels, or a quarter of the number of VGA pixels), for example);

bit rate conversion (from 8 Mbps (megabit per second) to 384 kbps (kilobit per second), for example); and

frame rate conversion (from 30 fps (frame per second) to 15 fps, for example), the transcoder unit 113 executes all of these conversions in real time, and then outputs the converted stream to the file conversion unit 114. If there is no instruction for the conversion, the transcoder unit 113 passes the input stream without alteration to the file conversion unit 114.

The file conversion unit 114 receives the instruction for the conversion from the analysis unit 117. When file conversion is necessary, the file conversion unit 114 converts the input stream to a predetermined file format, and outputs the converted file to the protocol conversion unit 115.

As the file format, one of the following file formats may be employed:

3GP file format;

MP4 file format;

Flash file; and the like.

It is assumed hereinafter that the 3GP file format is employed. Details of the 3GP file format can be referred to the 3GPP TS26.244 standard, for example. If there is no need for the file conversion, the file conversion unit 114 outputs the stream without alteration.

The protocol conversion unit 115 receives the file format or the stream.

When the instruction from the analysis unit 117 indicates protocol conversion, then conversion from RTP/UDP protocol to HTTP/TCP protocol is performed, for example, and the 3GP file is linked to HTTP protocol, for example, for output to the packet transmission unit 116.

The packet transmission unit 116 constructs a packet for the input protocol, and sends the packet.

In addition to the TV 157, a DVD recorder or the like can be connected to the STB 155 as an apparatus connected to the STB 155, in the above-mentioned embodiment.

A home gateway or the like can also be disposed in place of the STB 155 or can be disposed in a stage before the STB 155. A home server or the like can also be connected to the home gateway.

As the mobile network 140 of the second network, not only the mobile packet network described in the first exemplary embodiment but also a WiMax network, an LTE network, or the like having the same configuration as the mobile packet network can also be employed. Alternatively, a network using a Femto cell access point and having the same configuration as the mobile packet network can also be employed.

Alternatively, as the second network, a W-LAN network can also be used as the mobile network 140. Even in this case, the conversion apparatus 110 may have the same configuration.

As the second network, a mobile circuit switched network can also be employed as the mobile network 140. In this case, however, there is the need for altering the configurations of the control signal conversion unit 111 and the packet transmission unit 116 in the conversion apparatus 110. The configuration of the control signal conversion unit 111 is altered so that the control signal conversion unit 111 can receive a call control signal (of ISUP (ISDN User Part (user part) or the like) for mobile circuit switching. The packet transmission unit 116 is not necessary and is replaced by an H. 223 transmission unit. The H. 223 transmission unit supports a mobile circuit switching TV phone protocol such as 3G324M. The H. 223 is a low bit-rate multimedia multiplexing and demultiplexing protocol, recommended by the ITU-T (International Telecommunication Union Telecommunication Standardization sector). The 3G324M protocol is a 3GPP protocol for a TV phone, and provides an interactive type multimedia service between terminals in a mobile layer communication network.

As a codec used for compression encoding of video content, a known codec other than the MPEG-2 codec, such as an H. 264 codec recommended by the ITU can be used.

As a codec obtained by the conversion at the transcoder unit 113, a known codec other than the MPEG-4 codec such as the H. 264 codec, a WMV (Windows (registered trademark) Media Video), or the like codec can be employed.

As a file format obtained by the conversion at the file conversion unit 114, other known formats can be employed.

A protocol obtained by the conversion at the protocol conversion unit 115, other known protocols can be employed.

The above-mentioned exemplary embodiment deals with content obtained by compression encoding of a video signal. A still image, an audio signal, or the like can also be handled by the same configuration.

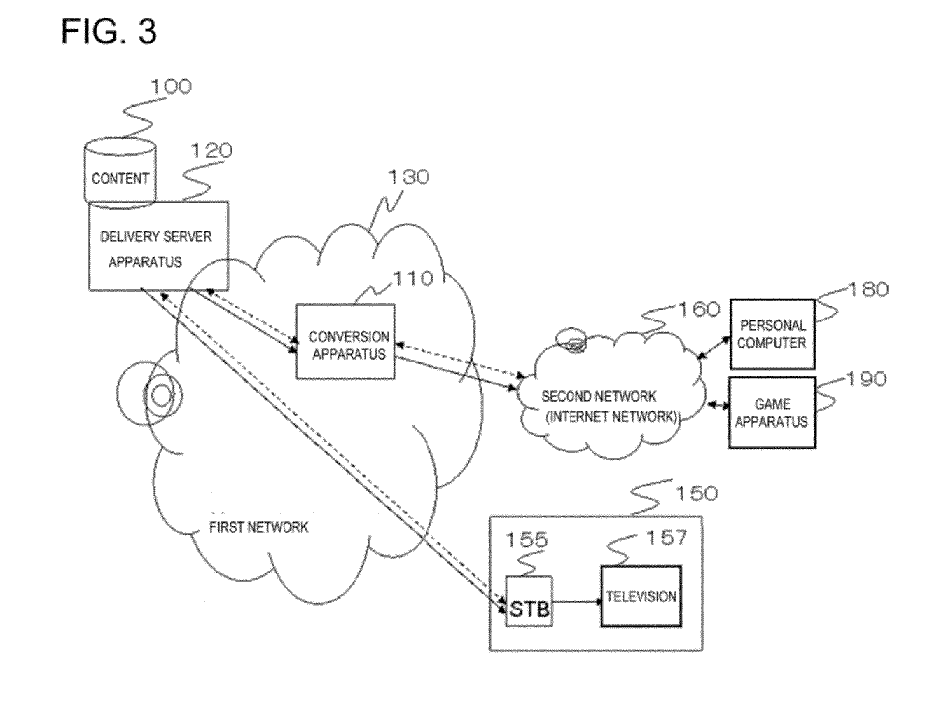

FIG. 3 is a block diagram showing a second exemplary embodiment of the present invention. In FIG. 3, components to which the same reference numerals as those in FIG. 1 are assigned perform the same operations as those in FIG. 1. Accordingly, description of these components will be omitted.

FIG. 3 shows a connection configuration when a personal computer 180, a game apparatus 190, or the like other than the portable terminal 170, for example, is connected as a second terminal. Each of the personal computer 180 and the game apparatus 190 transmits a connection request signal to the conversion apparatus 110 over the Internet network 160 as a second network, using a protocol (such as HTTP) specific to the terminal.

Since communication with the conversion apparatus 110 after the personal computer 180 or the game apparatus 190 transmits the connection request signal to the conversion apparatus 110 is similar to that in the case of the portable terminal 170, description of the communication with the conversion apparatus 110 will be omitted.

A digital photo frame may be employed in place of the game apparatus 190.

Conversion suited to the second terminal (such as portable terminal, game apparatus, personal computer, digital photo frame or the like) is performed on content that are the same as those delivered to a set top box in home and a TV or a DVD recorder connected to the set top box over a first network (such as IP network, broadband network, NGN, or the like). Then, the converted content is transmitted to the second terminal over the second network (such as mobile network, internet network, or the like). With this arrangement, there is achieved an effect that a service of delivering same content to various terminals can be implemented. By this effect, there is achieved an effect of eliminating the need for preparing content for each terminal in advance, eliminating the need for work necessary for preparing the content, and reducing a storage capacity for storing the content different for each terminal.

Each disclosure of Patent Documents and Non-patent document listed above and the like is incorporated herein by reference. Modifications and adjustments of the exemplary embodiments and an example are possible within the scope of the overall disclosure (including claims) of the present invention, and based on the basic technical concept of the invention. Various combinations and selections of various disclosed elements are possible within the scope of the claims of the present invention. That is, the present invention of course includes various variations and modifications that could be made by those skilled in the art according to the overall disclosure including the claims and the technical concept.

1. A delivery system comprising:
a delivery server that delivers content to a first terminal over a first network; and
a conversion apparatus connected to said first network and a second network, wherein said conversion apparatus, on receipt of a request from a second terminal over said second network, sends a request to said delivery server over said first network, and
when said conversion apparatus determines that conversion of content sent from said delivery server that receives said request is necessary with regard to at least one of
said second terminal,
said second network, and
said first network,
said conversion apparatus performs said conversion, and sends said converted content to said second terminal over said second network.

2. The delivery system according to claim 1, wherein said conversion apparatus performs, for said content, conversion of at least one of
codec,
bit rate,
screen resolution,
frame rate,
protocol, and
file format.

3. The delivery system according to claim 1, wherein said first terminal comprises one of
a set top box,
a television,
a home gateway,
a home server, and
a DVD (Digital Versatile Disk) recorder.

4. The delivery system according to claim 1, wherein said second terminal comprises one of
a portable terminal,
a personal computer,
a game apparatus, and
a digital photo frame.

5. The delivery system according to claim 1, wherein said first network comprises one of
an IP (Internet Protocol) network,
a broadband network,
an NGN (Next Generation Network), and
an Internet network, and wherein said second network comprises one of
a mobile packet network,
a mobile circuit switched network,
an IP network,
an Internet network,
a W-LAN network,
a WiMax network,
an LTE (Long Term Evolution) network,
a femto cell access point,
an HNB (Nome Node B), and
an HeNB (Home eNode B).

6. A delivery method, comprising:
delivering content from a delivery server to a first terminal over a first network;
sending a request to the delivery server, from a conversion apparatus, on receipt of said request from a second terminal over a second network; and
performing, by said conversion apparatus, conversion of said content sent from said delivery server that receives said request, when said conversion of said content is necessary with regard to at least one of
said second terminal,
said second network, and
said first network, and sending said converted content to said second terminal over said second network.

7. The delivery method according to claim 6, comprising:
performing, for said content, conversion of at least one of
codec,
bit rate,
screen resolution,
frame rate,
protocol, and
file format.

8. A conversion apparatus connected to a delivery server over a first network and connected to a second terminal over a second network, said delivery server delivering content to a first terminal over said first network, said conversion apparatus comprising:
a unit that sends a request to said delivery server over said first network, on receipt of said request from said second terminal over said second network;
a unit that performs conversion of content sent over said first network from said delivery server that receives said request, when said conversion of said content is necessary with regard to at least one of
said second terminal,
said second network, and
said first network; and
a unit that sends said converted content to said second terminal over said second network.

9. The conversion apparatus according to claim 8, wherein said conversion apparatus comprises:
a control signal conversion unit;
an analysis unit;
a transcoder that decodes encoded content from said delivery server, and re-encodes said decoded content;
a file conversion unit that performs file conversion; and
a protocol conversion unit,
wherein said control signal conversion unit receives capability information from said second terminal and capability information on said content from said delivery server and determines whether or not said conversion of said content is necessary; and
when said conversion of said content is necessary, said analysis unit performs at least one of
instructing said transcoder to perform one of
codec conversion,
screen resolution conversion,
frame rate conversion, and
bit rate conversion,
instructing said file conversion unit to perform at least one of file format generation; and
Flash file generation, and
instructing said protocol conversion unit to perform protocol conversion.

10. (canceled)

11. The delivery method according to claim 6, wherein said first terminal comprises one of
a set top box,
a television,
a home gateway,
a home server, and
a DVD (Digital Versatile Disk) recorder.

12. The delivery system according to claim 6, wherein said second terminal comprises one of
a portable terminal,
a personal computer,
a game apparatus, and
a digital photo frame.

13. The delivery method according to claim 6, wherein said first network comprises one of
an IP (Internet Protocol) network,
a broadband network,
an NGN (Next Generation Network), and
an Internet network, and wherein said second network comprises one of
a mobile packet network,
a mobile circuit switched network,
an IP network,
an Internet network,
a W-LAN network,
a WiMax network,
an LTE (Long Term Evolution) network,
a femto cell access point,
an HNB (Nome Node B), and
an HeNB (Home eNode B).

14. The conversion apparatus according to claim 8, wherein said first terminal comprises one of
a set top box,
a television,
a home gateway,
a home server, and
a DVD (Digital Versatile Disk) recorder.

15. The conversion apparatus according to claim 6, wherein said second terminal comprises one of
a portable terminal,
a personal computer,
a game apparatus, and
a digital photo frame.

16. The conversion apparatus according to claim 6, wherein said first network comprises one of
an IP (Internet Protocol) network,
a broadband network,
an NGN (Next Generation Network), and
an Internet network, and wherein said second network comprises one of
a mobile packet network,
a mobile circuit switched network,
an IP network,
an Internet network,
a W-LAN network,
a WiMax network,
an LTE (Long Term Evolution) network,
a femto cell access point,
an HNB (Nome Node B), and
an HeNB (Home eNode B).
